(19) United States
(12) Patent Application Publication
(10) Pub. No.: US 2008/0271757 A1
(43) Pub. Date: Nov. 6, 2008

(54) ORBITAL SCRUBBER

(75) Inventor: Kevin Blaine Mitchell, West Fork, AR (US)

Correspondence Address: HUSCH BLACKWELL SANDERS LLP, 720 OLIVE STREET, SUITE 2400, ST. LOUIS, MO, 63101, US

(73) Assignee: ALTO U.S. INC., Springdale, AR (US)

(21) Appl. No.: 12/174,961

(22) Filed: Jul. 17, 2008

Related U.S. Application Data
(62) Division of application No. 10/905,575, filed on Jan. 11, 2005.

(51) Int. Cl. B08B 5/04; B08B 7/02

(52) U.S. Cl. 134/21

(57) ABSTRACT

This orbital motion scrubber uses less cleaning solution than many conventional rotary motion scrubbers of comparable scrub width and tank size, which results in longer solution run time. The present invention drives the cleaning element in a high speed orbital motion which results in more revolutions per spot than many conventional rotary motion scrubbers. A flexible pad driver produces better cleaning of uneven hard surface floors than some prior art designs with rigid pad drivers. The brush motor that drives the pad driver and the cleaning element of the present invention uses less electrical energy than the brush motor in many rotary motion scrubbers which results in longer battery run time.

### CROSS REFERENCE TO RELATED APPLICATION

This application is a Divisional application of application Ser. No. 10/905,575 filed Jan. 11, 2005, now published, of the same title, the disclosure of which is incorporated herein by reference.

### BACKGROUND OF INVENTION

Rotary type scrubbers have been used for decades to clean hard floor surfaces such as tile, linoleum, and concrete. These hard floor surfaces are often uneven which presents challenges to the scrubber and may result in a floor that is not cleaned in a uniform fashion. One approach to uneven floors is a gimbaled disc shaped scrub brush. The gimbaled design allows some degree of freedom to the brush allowing it to tilt in response to the uneven floor.

Another challenge to conventional floor cleaning is excess water consumption. In the past, it was a widely held belief that the more water that was applied to the floor, the cleaner it could be scrubbed. Within the last few years, this notion has fallen from favor as the floor cleaning industry has become more ecologically conscious. Various approaches have been developed by several floor equipment companies using rotary type scrubbers discussed below.

One approach to the challenge of excess water consumption was developed by the Tennant Company of Minneapolis, Minn. (www.tennantco.com) and is disclosed in U.S. Pat. Nos. 6,585,827; 6,705,332 and 6,705,662. Tennant calls this the FaST™ foam scrubbing technology. Tennant promotional material represents that this technology increases scrubbing productivity up to 30% for rotary type scrubbers. However, this rotary type scrubber still has splash skirts.

Yet another approach to the challenge of excess water consumption was developed by Windsor Industries of Denver, Colo. (www.windsorind.com) and is referred to as the Aqua-Mizer™ which is disclosed in a published patent application entitled “Scrubbing Machine Passive Recycling”, published Apr. 17, 2003, Publication Number 2003-0070252. Windsor promotional material represents that this technology increases run-time productivity by 35 to 50% per tank fill up. This system apparently is standard on all of the Windsor Saber Cutter models which are rotary type scrubbers. However, this rotary type scrubber still has splash skirts.

A different approach to the challenge of excess water consumption has been developed by Penguin Wax Co. Ltd., of Osaka, Japan (www.penguinwas.co.jp). Penguin offers a scrubber called the “Shuttlematic” model numbers SQ 200 and the SQ 240. Instead of the rotary motion of the aforementioned floor scrubbers, the Shuttlematic uses two flat pads positioned perpendicular to the direction of travel of the machine. Penguin promotional material represents that the Shuttlematic has longer run time, less power consumption and no water splash. The Shuttlematic does not have splash skirts. Another prior art shuttle type design without splash skirts is disclosed in U.S. Pat. No. 1,472,208. The shuttle motion of the '208 patent is different from the shuttle motion of the Shuttlematic. Notwithstanding the aforementioned prior art scrubbers, there is still a need for a floor cleaning machine that will conserve water and power and still do a good job scrubbing uneven hard floor surfaces.

Applicant has developed a different approach that conserves water and power and still does an excellent job scrubbing uneven hard floor surfaces. The present invention is an orbital scrubber. It is a marriage between some of the features found in prior art rotary motion scrubbers for hard floor surfaces and some of the features found in prior art orbital motion sanders for finishing wood floors. Applicant's assignee of the present invention, Clarke, a division of ALTO U.S. Inc. has previously sold an orbital motion sander for finishing wood floors, model number OBS 18, among others, as pictured on the advertisement and operator's manual included in the information disclosure statement filed concurrently herewith. This orbital motion has been combined with some of the features of the prior art rotary motion Encore scrubbers also sold by Clarke, a division of ALTO U.S. Inc. Operator's manuals for various Encore rotary motion scrubbers are likewise included in the information disclosure statement filed concurrently herewith.

In the mid-1960's, Clarke introduced an orbital motion scrubber for hard floor surfaces, model number BP-18-SP, which was on sale for several years during which more than a thousand units were sold. The BP-18 did a poor job cleaning uneven floors. Apparently, customers would make an initial purchase, but follow-up sales were difficult to close because of the uneven cleaning problem. Sales eventually dried up. The BP-18 had a high solution flow rate of approximately 1.1 gallons per minute at the full flow setting and therefore required splash skirts around the cleaning head assembly. In contrast, the present invention uses comparatively low cleaning solution flow rates and therefore no splash skirts are needed. The BP-18 was a failed attempt from the mid-1960's at an orbital motion scrubber.

The BP-18 failed for a number of reasons, but certainly one of the reasons was because the pad driver was a rigid piece of metal that did not flex in response to uneven features in the floor. As a result, the cleaning was uneven. The cleaning pad on the BP-18 was thin and thus easily damaged. (This prior art cleaning pad was about 0.19 inches thick). Furthermore, tools were required to make a pad change. Further, the BP-18 had a fixed weight of 35 pounds that applied this non-adjustable load on the cleaning head. Notwithstanding this prior art orbital motion scrubber for hard floor surfaces, and prior art orbital motion sanders for finishing wood floors and prior art rotary motion scrubbers, there is still a need for a floor cleaning machine that will conserve water and power and still do a good job scrubbing uneven hard floor surfaces.

### SUMMARY OF THE INVENTION

The present invention uses high speed orbital motion to move a flexible pad driver attached to a removable cleaning element. The cleaning element makes more revolutions per spot on the floor than many conventional rotary motion scrubbers. The term “cleaning element” as used herein includes both cleaning pads and brushes with bristles. Unlike some prior art attempts, no tools are required to change the cleaning element on the present invention. Cleaning solution is evenly applied to the floor immediately in front of the cleaning element in quantities that are comparatively less than usage of many conventional rotary motion scrubbers of comparable scrub width. Less cleaning solution consumption equates to a longer run time between tank refills. Because less cleaning solution is used, the present invention does not need or have splash skirts. The absence of splash skirts allows the orbital scrubber to get into tight places and into a square corner. The orbital scrubber also uses less electrical energy than conventional rotary motion scrubbers of comparable scrub width. A flexible pad driver results in better cleaning of uneven floor surfaces than some prior art designs with rigid pad drivers.

### BRIEF DESCRIPTION OF DRAWINGS

FIG. 1 is a schematic of a prior art rotary motion scrubber.

FIG. 2 is a side view of the present invention, the orbital scrubber.

FIG. 3 is a front view of the cleaning head of the orbital scrubber of FIG. 2.

FIG. 4 is an exploded front view of the cleaning head of FIG. 3.

FIG. 5 is an exploded side view of the cleaning head of FIG. 3.

FIG. 6 is a front view of the cleaning head of FIG. 3 when it encounters an uneven floor surface.

FIG. 7 is a side view of the cleaning head of FIG. 3 as it flexes to scrub an uneven floor surface.

FIG. 8 is an exploded perspective view of the cleaning head and the front of the orbital scrubber.

FIG. 9 is a cross-sectional view of a vibration dampening element.

FIG. 10 is a perspective view of a flexible pad driver and a removable cleaning brush.

### DETAILED DESCRIPTION

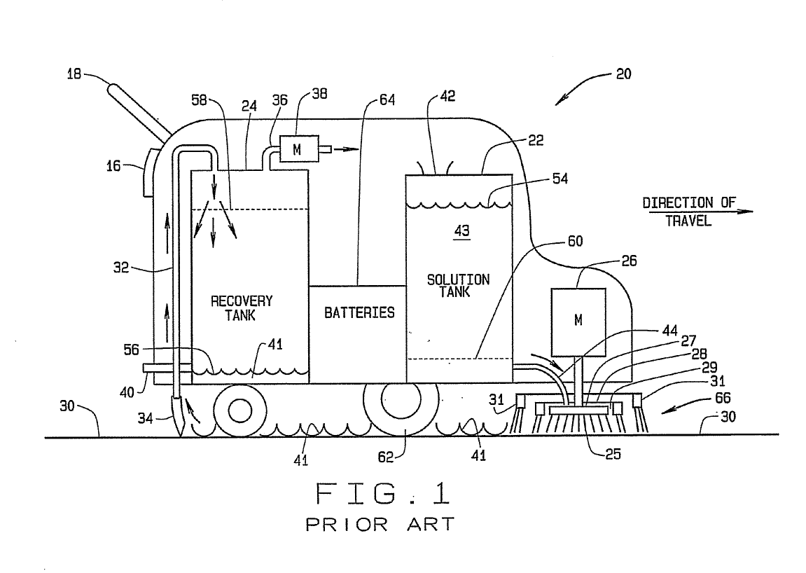

FIG. 1 is a schematic diagram of a prior art rotary motion type scrubber generally identified by the numeral 20. These scrubbers can use disc shaped brushes or cleaning pads that operate in a rotary motion about the shaft of the brush motor. These scrubbers are therefore referred to herein as rotary motion type scrubbers. Scrubbers of this type are designed to clean hard floor surfaces such as tile, linoleum, and concrete. These rotary motion scrubbers are typically used in medical facilities, office buildings, educational facilities, restaurants, convenience stores, and grocery stores.

The operator, not shown, walks behind the scrubber 20 and grips the handle 18 to control the direction of travel as indicated by the arrow at the front of the scrubber. A control panel 16 is positioned at the rear of the scrubber and has various control devices and systems well known to those skilled in the art. The control devices and systems are in electrical connection with the various operating components of the scrubber. There is no standardized set of control devices and systems on each and every rotary scrubber, but the following are available on some rotary scrubbers.

There is typically an on/off switch, not shown, and a cleaning head assembly position control device. The cleaning head assembly typically has an upper position where the brush bristles are not in contact with the floor surface and a lower position where the brush bristles are in contact with the floor surface. When the on/off switch is “on” and the cleaning head assembly is put in the lower position, a touch down switch, not shown, activates the brush motor to scrub the floor.

There may be a control device to vary the amount of downward load on the cleaning head assembly. Some scrubbers have an adjustable actuator that varies the amount of downward load on the cleaning head assembly. Some scrubbers have weights on the cleaning head assembly that exert a constant load. For those scrubbers with adjustable load control devices, a heavy load is used for very dirty floors. Lightly soiled floors require minimum load. The heavier the load on the cleaning head assembly, the higher the amp. draw of the brush motor and the less the battery run time. The amp. draw of a ¾ HP brush motor for the present invention is greater than about 8 amps. and less than about 18 amps. depending on the amount of the downward load on the cleaning head.

There may be an adjustable speed control device, not shown, to control the speed of the traction motor which dictates the forward speed of the scrubber. Some scrubbers do not have traction motors and rely on the rotation of the brushes to help move the machine forward. However, on those scrubbers that have traction motors, the faster the speed the higher the amp. draw which reduces battery run time and vice-a-versa.

There may also be an adjustable flow control device, not shown, for the cleaning solution. There is typically a squeegee position control device, not shown. The squeegee 34 typically has a full up, full down and medium height position, which is typically a manual lever. The squeegee 34 also has a touch down switch, not shown, to turn on the vacuum motor 38 when the squeegee 34 is in the full down position to suck up dirty fluid 41. The medium setting on the squeegee 34 is to clear the squeegee conduit 32 when scrubbing is complete so it does not drip dirty fluid on a clean floor or elsewhere. The full up position is used to move the scrubber 20 from place to place when scrubbing is not desired, as over clean floors, or back to the janitor's closet to drain the recovery tank 24 and refill the solution tank 22.

The rotary motion scrubber 20 has a solution tank 22 and a recovery tank 24. A brush motor 26 drives a disc shaped brush 28 which has bristles 25 which engage the hard surface floor 30. A conduit 32 connects the squeegee 34 to the recovery tank 24. A conduit 36 connects the recovery tank 23 with the vacuum motor 38 which is vented to atmosphere. A drain 40 is used to drain the dirty fluid 41 from the recovery tank 24.

Concentrated cleaning solution 43 is poured into the solution tank 22 through the solution tank inlet 42. The cleaning solution 43 is a liquid and typically includes a mixture of tap water and a cleaning agent such as concentrated floor soap. Typically, the concentrated cleaning agent is poured into the solution tank 22 and then tap water is added in the desired amount. In most situations, the solution tank 22 is filled to the top with water and concentrated floor soap. When the scrubber is scrubbing, the cleaning solution 43 passes from the solution tank 22 through the solution conduit 44 to the brush 28. The cleaning solution is then scrubbed against the floor 30 by the rotating bristles 25 of the brush 28. As the scrubber 20 moves forward as indicated by the arrow 52, a squeegee 34 sucks up the dirty fluid 41 from the floor 30 and the dirty fluid moves through the conduit 32 into the recovery tank 24.

As shown in FIG. 1 the scrubber 20 has just begun a shift and there is more cleaning solution 43 in the solution tank 22, as indicated by the fluid level line 54 than dirty fluid 41 in the recovery tank as indicated by the fluid level line 56. However, when the recovery tank 24 is full as indicated by the dashed fluid level line 58, the solution tank 22 will be empty or nearly empty as indicted by the dashed fluid level line 60. When the recovery tank is full as indicated by the fluid level line 58, a float shut off switch turns off the brush motor 26 and the vacuum motor 38. The operator therefore knows it is time take the scrubber to a janitor's closet or other suitable location to drain the recovery tank through the drain 40. The process is then repeated. The solution tank 22 is refilled with a mixture of water and concentrated cleaning solution 43 and the scrubber can be taken back to a work area and can recommence scrubbing the floor. The batteries 64 are typically recharged overnight after the job is completed.

Most scrubbers, like the scrubber 20 have traction wheels 62 that facilitate movement of the scrubber to and from the work area to the janitor's closet. Some scrubbers have a traction motor, not shown to power the traction wheels 62. All scrubbers like the scrubber 20 have a power supply to power the brush motor 26, the vacuum motor 38 and if so equipped, the traction motor. In some scrubbers, the power supply is two or more 12 or 6-volt DC rechargeable batteries 64, mentioned above. In other scrubbers the power supply is 110 volts AC or 220 volts AC. When AC powered, the scrubber has a long extension cord used to access wall mounted AC receptacles.

While scrubbing, cleaning solution 43 passes through the cleaning solution conduit 44 and feeds out by gravity to the top of the brush 27. The brush has a plurality of holes 29 through the top of the brush 27 that allow some of the cleaning solution 43 to pass through the brush to the bristles 25 and the floor 30. Unfortunately, the brush 28 is rotating at about 200-300 RPM so much of the cleaning solution 43 is flung off the top of the brush 27 by centrifugal force. Splash skirts 31 surround the brushes 28 to contain the cleaning solution that is being flung off the top of the brush 27. To Applicant's knowledge, all rotary motion floor scrubbers have some type of splash skirt to contain the cleaning solution that is flung off the top of the brush 27. The cleaning head is generally identified in FIG. 1 by the numeral 66. The cleaning head is an assembly that typically includes one or two brushes contained by a splash skirt on the front and sides of the cleaning head. In the industry, the terms cleaning head, rotary head, scrub head and brush head are used interchangeably.

An actuator, not shown applies downward forces on the cleaning head 66 to facilitate cleaning of uneven floors. Really dirty floors require more load on the cleaning head 66. However, heavier loads on the cleaning head 66 require more electricity to drive the brush 28. The load or downward pressure on the cleaning head can be up to about 200 lbs. depending on the machine. For example, the Clarke, Encore 17″ scrubber can apply from 0 to about 90 lbs. of force on the cleaning head; the Encore 24″-26″ scrubbers can apply from 0 to about 150 lbs. of force on the cleaning head. The Encore 28″ to 38″ can apply from about 120 lbs. to about 220 lbs of force to the cleaning head. The cleaning head 66 can be moved from the lower position shown in FIG. 1 where the bristles 25 engage the floor 30 to an upper position, not shown, so the bristles do not touch the floor. The upper position is used when the scrubber needs to be moved about from one place to the next. The lower position, shown in FIG. 1 is used when the floor cleaning machine is scrubbing the floor.

The Encore 2426 has a “battery run time” of about 3-4 hours before the rotary scrubber needs to be recharged. The Encore 2426 has a “solution run time” between tank refillings/emptying of about one hour. In other words, it takes about one hour of floor scrubbing to use all of the cleaning solution in the 20 gal. solution tank, at the half flow setting. Then it is time to take the rotary motion scrubber to the deep sink in the janitors' closet or other suitable location for draining. The recovery tank is then refilled with cleaning solution and the scrubber is taken back to the work area for more scrubbing. It may take the operator 30-40 minutes to complete a refill cycle including the trip back and forth to and from the deep sink. So if the number of refills per hour can be reduced it means time saved and is an advantage for any floor cleaning machine.

One reason the Encore 2426 uses so much cleaning solution is the disc type brush that rotates at approximately 200 RPM. As previously discussed, the centrifugal force created by rotation to the disc type brush drives the cleaning solution away from the brush and bristles. This solution never gets used for scrubbing purposes and is controlled by the splash skirt and picked up by the squeegee. These brushes may be adjusted from a width of about 24 inches to a width of about 26 inches and thus the model number 2426.

The present invention in the 2426 version can use a ¾ HP direct drive brush motor which causes the cleaning element to orbit at about 2,250 RPM. The ¾ HP brush motor will draw about 10-14 amps while scrubbing. But because the motion is orbital rather than rotational, the cleaning solution is not driven away from the cleaning pad so less cleaning solution is needed for the same amount of floor space and no splash skirts are required. In addition, because the motor draws less current it may also extend the run time of the batteries.

The present invention in a 2426 version has a battery run time of about of about 5-6 hours before the orbital scrubber needs to be recharged. The present invention in a 2426 version with a 20 gal. solution tank has a solution run time at the half flow setting of about 100 minutes; whereas, the Encore 2426 with a 20 gal. solution tank has a solution run time at half flow setting of about 57 minutes. For comparison purposes, the present invention, with a 20 gal. solution tank uses about 0.6 refills per hour (60 min.÷100 min), at the half flow setting; whereas an Encore 24″ with the same size tank uses about 1 refill per hour at the half flow solution setting (60 min÷57 min). It is a distinct advantage to run the machine longer between refills to eliminate the wasted time walking back and forth to the janitor's closet and the time it takes to drain and refill the machine. Thus the present invention has a clear advantage because it uses less water and therefore requires fewer tank refills compared with most prior art rotary scrubbers.

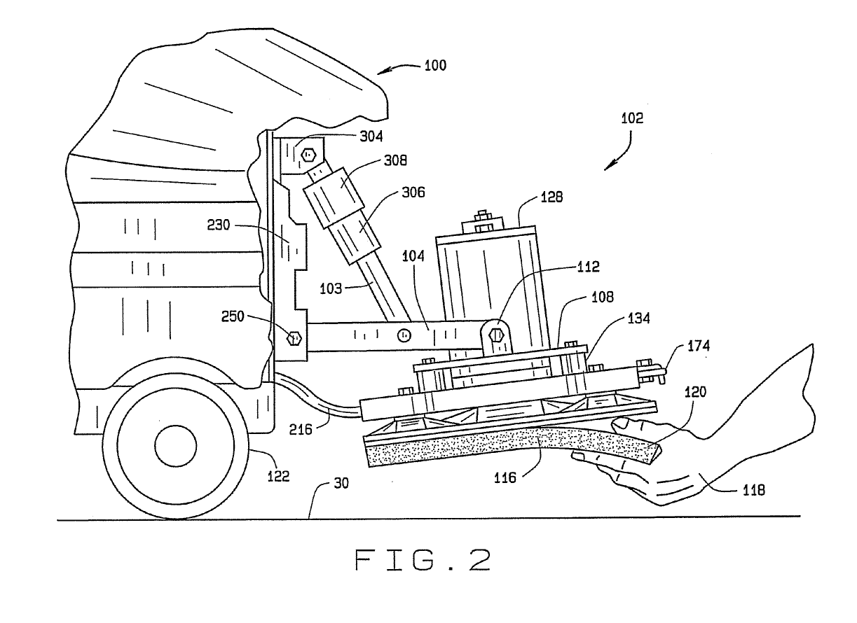

FIG. 2 is a side view of the present invention, the orbital scrubber which is generally identified by the numeral 100. The cleaning head is generally identified by the numeral 102. The orbital scrubber shown in this and subsequent drawings uses a cleaning element 116. The term cleaning element 116 as used in this application includes both removable cleaning pads 117 and removable cleaning brushes 296, of FIG. 10. Various flexible cleaning pads 117 have been found suitable as a cleaning element 116, including various pads sold by 3M of Minneapolis, Minn., such as the high productivity pad 7300, the black stripper pad 720, the eraser pad 3600, the red buffer pad 5100, the white super polish pad 4100 and the maroon between coats pad. Various removable cleaning brushes 296 may also be suitable as a cleaning element 116.

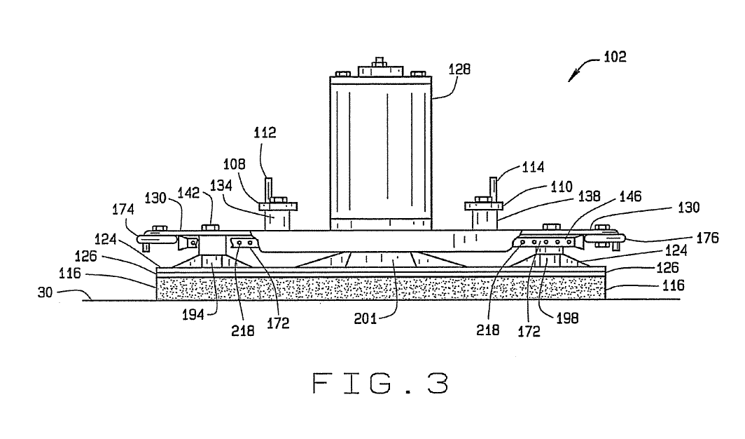

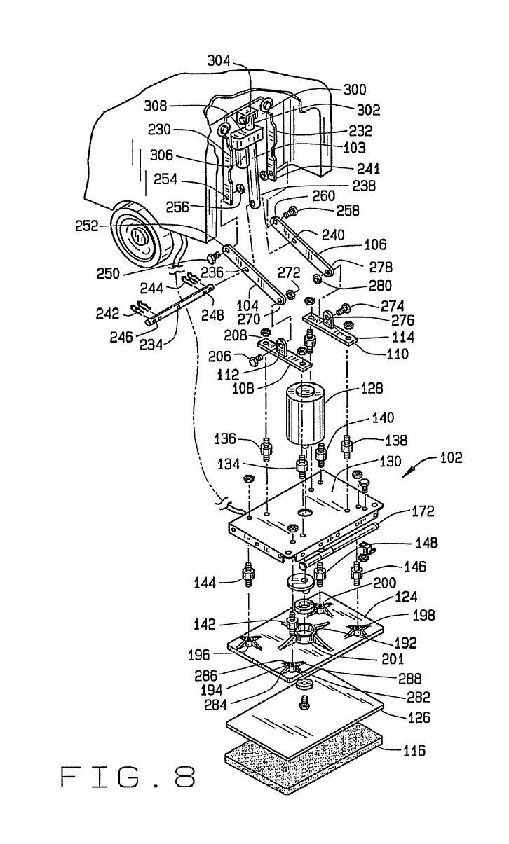

The orbital scrubber has a pair of adjustment arms 104 and 106, better seen in FIG. 8, that pivotally engage a left mounting bracket 108 and a right mounting bracket 110, better seen in the next figure. The left mounting bracket includes a left yoke 112 that adjustably connects to the left adjustment arm 104. The right mounting bracket includes a right yoke 114 that adjustably connects to the right adjustment arm, not shown in this figure. The cleaning head 102 has an upper position as shown in FIG. 2 so the pad can be changed or the orbital scrubber can be easily moved from one location to the other. The cleaning head 102 has a lower position shown in FIG. 3 for scrubbing the floor surface 30. In the lower position of FIG. 3, the cleaning element 116 engages the floor surface 30. A solution conduit 216 runs from the solution tank, not shown to the cleaning solution distribution tube 172, better seen 4, 5 and 8. Cleaning solution runs by gravity from the solution tank through the solution conduit 216 to the distribution tube 172 where it drips on the floor and/or the forward edge 120 of the cleaning element 116.

The adjustment arms, including the left arm 104 and the right arm, 106, not shown, raise the cleaning head assembly 102 to the upper position shown in FIG. 2 and they also lower the cleaning head assembly to the lower position shown in FIG. 3 in response to operation of the actuator. Adjustment control mechanisms are included in the orbital scrubber 100, but are not shown in detail because they are well know to those skilled in the art. The adjustment controls to raise and lower the cleaning head are often mounted on the control panel, not shown, on the rear of the orbital scrubber.

In FIG. 2, the operator's hand 118 is gripping the forward edge 120 of the cleaning element 116 to remove it from the cleaning head assembly 102. From time to time, cleaning elements wear out or may be damaged and thus need to be replaced. A new cleaning element is installed in an opposite manner to the removal process. No tools are required to remove or install a new cleaning element on the present invention making it easy to replace a cleaning element. After the cleaning element has been replaced, the operator actuates the drive wheels 122 and directs the machine to the work area. The operator then lowers the cleaning head assembly 102 so the cleaning element 116 is in contact with the floor surface 30, as shown in the next figure. The raising and lowering of the cleaning head assembly 102 is accomplished by the actuator 103. A control panel, not shown is positioned on the rear of the machine near the operator. Various control devices, not shown are located on the control panel including control devices to raise and lower the cleaning head as is well known to those skilled in the art.

FIG. 3 is a front view of the cleaning head assembly 102 of the orbital scrubber of FIG. 2 removed from the rest of the machine to better show the components of the cleaning head assembly 102. As previously mentioned, the left mounting bracket 108 includes a left yoke 112 which connects to the left adjustment arm 104, better seen in FIG. 2. The right mounting bracket 110 includes a right yoke 114 which connects to the right adjustment arm, not shown. Together, the adjustment arms raise and lower the cleaning head assembly 102 from the lower scrubbing position of FIG. 3 to the upper position of FIG. 2. In FIG. 3, the cleaning element 116 is in contact with the floor surface 30 so the scrubbing process can begin.

In FIG. 3, the cleaning element 116 is removably connected to the pad driver 124 by an attaching means 126. A hook and loop attaching means has been found suitable for this purpose, but any other attaching means that will removably and securely hold the cleaning element to the pad driver 124 will suffice. The hook and loop is particularly suitable because it does not require any tools to replace the pad. In this figure, the attaching means 126 is shown as a separate part from the pad driver 124. However, this is merely a matter of manufacturing convenience. The attaching means 126 may be formed as a single unit with the pad driver 124.

The brush motor 128 is mounted on the motor mounting plate 130. FIG. 3 shows a pad and not brushes. However, the term “brush motor” is commonly used in the industry to identify the motor on the cleaning head regardless of whether brushes or a pad is being used. The term brush motor also distinguishes the motor on the cleaning head 102 from the traction motor, not shown, that powers the drive wheels 122, better seen in the preceding figure.

Prior art rotary motion scrubbers typically use brushes that rotate about the centerline of the driveshaft of the brush motor. The present invention uses a cleaning element 116 that orbits about the centerline of the driveshaft of the brush motor and hence it is called an “orbital scrubber”. The orbital movement is imparted to the cleaning element 116 by an eccentric cam 132, better seen in the next figure. The cleaning element may orbit at speeds exceeding 2000 revolutions per minute which induces vibrations in the cleaning head 102. These vibrations need to be dampened to enhance the life of the orbital scrubber 100. A plurality of vibration dampening elements are positioned between the motor mounting plate 130 and the left and right mounting brackets, 108 and 110. A plurality of vibration dampening elements is also positioned between the motor mounting plate 130 and the pad driver 124. The number, location and type of vibration dampening elements will vary according to the size of the cleaning element, the size of the brush motor 128, the weight of the eccentric cam 132 and other factors. In the present invention, using a 14 by 18 inch pad with a ¾ HP motor, and a 1.5 lb. eccentric cam, applicants have found that the model 135-162 rubber spring from Accurate Products, Inc. of Chicago, Ill. is a suitable vibration dampening element; any other vibration dampening element that has long service life will also be suitable. A first upper vibration dampening element 134 and a second upper vibration dampening element 136, better seen in the preceding figure, are located between the motor mounting plate 130 and the left mounting bracket 108. A third upper vibration dampening element 138 and a fourth upper vibration dampening element 140, not shown, are located between the motor mounting plate 130 and the right mounting bracket 110.

A first lower vibration dampening element 142 and a second lower vibration dampening element 144, better seen in the following figures are located between the motor mounting plate 130 and the pad driver 124. A third lower vibration dampening element 146 and an fourth lower vibration dampening element, not shown, are located between the motor mounting plate 130 and the pad driver 124. Other vibration dampening elements and configurations are within the scope of this invention. The cleaning solution distribution tube 172 is partially shown in the cutaway portions of the motor mounting plate 130. The cleaning solution distribution tube has a plurality of holes 218 therein to allow the cleaning solution 43 to flow out of the tube onto the floor. The holes 218 are shown for illustrative purposes at the 3 o'clock position, but in the actual embodiment, they are actually positioned closer to the 5 o'clock position. The number and size of the holes varies with the width of the cleaning element 116. Suggested flow rates are discussed below.

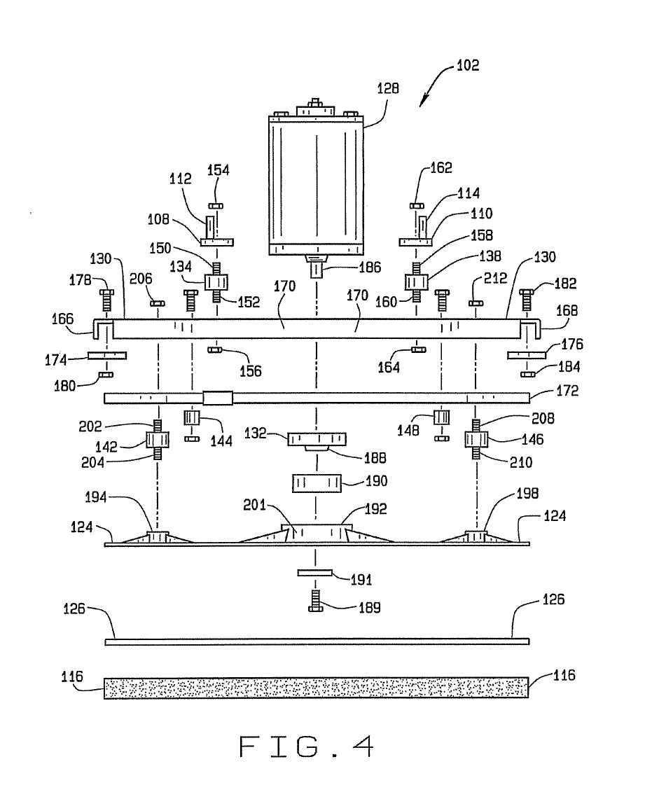

FIG. 4 is an exploded front view of the cleaning head 102 of FIG. 3. The brush motor 128 is mounted to the motor mounting plate 130. The first upper vibration dampening element 134 has a threaded shaft 150 extending from the top and another threaded shaft 152 extending from the bottom of the element. The shaft 150 passes through a hole, not shown in the left mounting bracket 108 and is secured by a nut 154. The shaft 152 passes through a hole, not shown in the motor mounting plate 130 and is secured by a nut 156. The third upper vibration dampening element 138 has a threaded shaft 158 extending from the top and another threaded shaft 160 extending from the bottom of the element 138. A nut 162 engages the threaded shaft, 158 attaching the top of the vibration dampening element 138 to the right mounting bracket 110. A nut 164 engages the threaded shaft, 160 attaching the bottom of the vibration dampening element 138 to the motor mounting plate 130.

The motor mounting plate 130 has a left lip 166, a right lip 168 and a front lip 170 formed at the outer extremities. These lips add rigidity to the motor mounting plate and protect the components housed there under, such as the pad driver 124 and the cleaning solution distribution tube 172. These lips, 166, 168 and 170 do not function as splash skirts like some of the prior art. The present invention does not have any splash skirts, because they are not needed as will be described in greater detail below.

In order to protect the cleaning head 102 and to avoid damage to walls and furniture, the head 102 is equipped with two bumper wheels, 174 and 176. A bolt 178 passes through a hole, not shown in the motor mounting plate 130 and a hole, not shown in the center of the left bumper wheel 174. A nut 180 threads on the extended portion of the bolt 178 to secure the left bumper wheel 174 to the motor mounting plate 130. The left bumper wheel 174 is free to rotate about the bolt 178. A bolt 182 passes through a hole, not shown in the motor mounting plate 130 and a hole, not show in the center of the right bumper wheel 176. A nut 184 threads on the extended portion of the bolt 182 to secure the right bumper wheel 176 which is free to rotate about the bolt 182. The left bumper wheel 174 and the right bumper wheel 176 extend beyond the motor mounting plate 130, as better seen in FIG. 3. The wheels 174, 176 will bump against walls, furniture and other fixtures to protect the cleaning head 102 and the scrubber 100 in general. They will also help prevent scrapes on walls and other fixtures, when the cleaning head 102 inadvertently contacts a wall or fixture.

The brush motor 128 causes a drive shaft 186 to rotate. The drive shaft 186 is mounted off center in the eccentric cam 132. An extension shaft 188 extends from and is integral with the eccentric cam 132. A ball bearing assembly 190 is pressed to fit in a journal 192 in the pad driver 124. The extension shaft 188 contacts the inside raceway of the ball bearing assembly 190. A bolt 189 passes through a washer 191 and threadably engages a hole, not shown in the extension shaft 188. When the brush motor 128 is “on” the drive shaft 186 rotates the eccentric cam which imparts orbital movement to the pad driver 124 because of the off center position of the drive shaft 186 in the eccentric cam 132. In other words, the drive shaft 186 and the extension shaft 188 are not in alignment which imparts the orbital movement to the pad driver 124.

The pad driver 124 forms a left front mounting pedestal 194, a left rear mounting pedestal 196, better seen in FIG. 8, a right front mounting pedestal 198, and a right rear mounting pedestal 200, better seen in FIG. 8. The first lower vibration dampening element 142 has an upper threaded shaft 202 extending from the top thereof and a lower threaded shaft 204 extending from the bottom of the vibration dampening element 142. The lower threaded shaft 204 threadably engages a threaded hole, not shown in this figure, in the left front mounting pedestal 194. The upper threaded shaft 202 passes through a hole, not shown in the motor-mounting plate 130 and engages a nut 206. The third lower vibration dampening element 146 has an upper threaded shaft 208 extending from the top thereof and a lower threaded shaft 210 extending from the bottom. The lower threaded shaft 210 engages a threaded hole, not shown in this figure, in the right front mounting pedestal 198. The upper threaded shaft 208 passes through a hole, not shown in the motor mounting plate 130 and engages a nut 212.

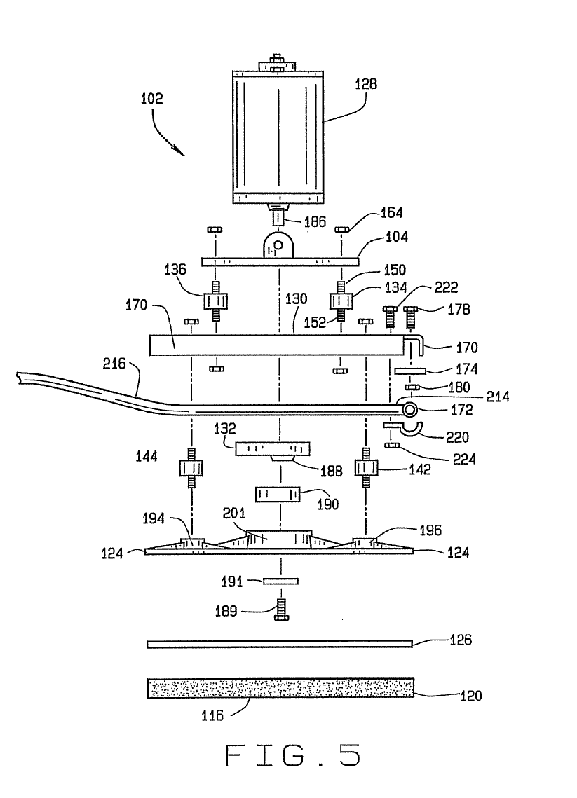

FIG. 5 is an exploded side view of the cleaning head 102 of FIG. 3. The distal end 214 of the solution conduit 216 connects to the cleaning solution distribution tube 172 which has a plurality of holes 218 therein. The proximal end, not shown of the solution conduit 216 connects to the solution tank. Cleaning solution flows by gravity from the solution tank, not shown, through the solution conduit 216 to the cleaning solution distribution tube 172 where the cleaning solution drips through the holes 218 onto the floor surface 30 and the forward edge 120 of the cleaning element 116. The cleaning solution distribution tube 172 is located proximal the forward edge 120 of the cleaning element 116 and is secured by a plurality of brackets on one of which, 220 is shown in this view. A bolt 222 passes through a hole, not shown in the motor mounting plate 130 and a hole, not shown in the bracket 220. A nut 224 threads onto the bolt 222 and secures the bracket 220 and thus the cleaning solution distribution tube 172. The cleaning solution is applied to the floor and/or the cleaning element by the cleaning solution distribution tube 172.

In an alternative embodiment, not shown, holes may be drilled in the pad driver 124 and the attaching means 126 so the cleaning solution may be applied to the top of the cleaning element 116. Because cleaning elements are porous, the force of gravity will draw the cleaning solution through the pad to the floor 30.

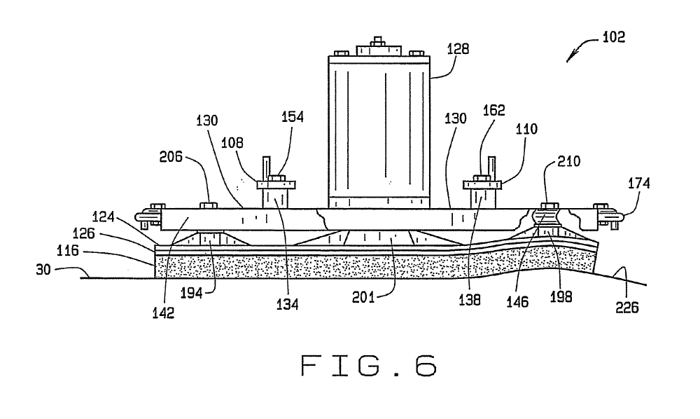

FIG. 6 is a front view of the cleaning head assembly 102 of FIG. 3 when it encounters an uneven floor surface 226. Unlike prior art pad drivers used in scrubbers, the flexible pad driver 124 of the present invention deflects to accommodate the uneven floor surface 226. Most of the components in the cleaning head assembly 102 are flexible including the cleaning element 116 and the attaching means 126 which further allows accommodation and bending to adapt to uneven floor surfaces, an example of which is shown as 226 for illustrative purposes. In addition, the upper and lower vibration dampening elements are flexible and can be distorted to further help accommodate to uneven floor surfaces. For illustrative purposes, the lower right front vibration dampening element 146 is shown in an exaggerated deflected state to help accommodate the uneven floor surface 226. Although the motor mounting plate 130 is rigid, it can tilt somewhat due to the flexibility of the upper vibration dampening elements, two of which can be seen in this view, 134 and 138.

The flexible pad driver 124 is an important feature of the present invention. The prior art orbital sanders sold by applicant's assignee require rigid pad drivers in order to smooth out any high spots on wooden floors. A rigid pad driver sands high spots continuously without getting into low spots until the wood floor is smooth and even. A flexible pad driver in the sanding application would work to exaggerate any high or low spots. The flexible drive plate 124 of the present invention allows the orbital scrubber to follow the contour of uneven hard floor surfaces without putting excessive scrubbing force on high spots in the floor. Excessive scrubbing force could cause damage to the finish on high spots on the tile floors. The pad driver must have enough flex to follow uneven floor contours yet have enough stiffness to transmit the proper amount of load and scrubbing force to clean the entire surface area. (The actuator applies downward force to the flexible pad driver and the cleaning element.) Prior art floor burnishers, also sold by applicant's assignee require a floppy pad driver as they are operated at high RPM's (typically more than 2,000 RPM) in order to polish a floor. The pad driver must be floppy enough to be sucked down to the floor due to the vacuum of the high RPM spinning of the pad driver. Only a very floppy pad driver can maintain contact with an uneven floor surface while burnishing, since there is no other force pushing or pulling down on it other than a vacuum. In conclusion, the pad driver can be too rigid and stiff, like the drivers used in prior art sanders, or it can be too flexible, like the drivers used in floor burnishers. The term “flexible pad driver” as used herein means one that is flexible enough to scrub uneven floor surfaces. The flexible pad driver may be produced from plastic, such as nylon.

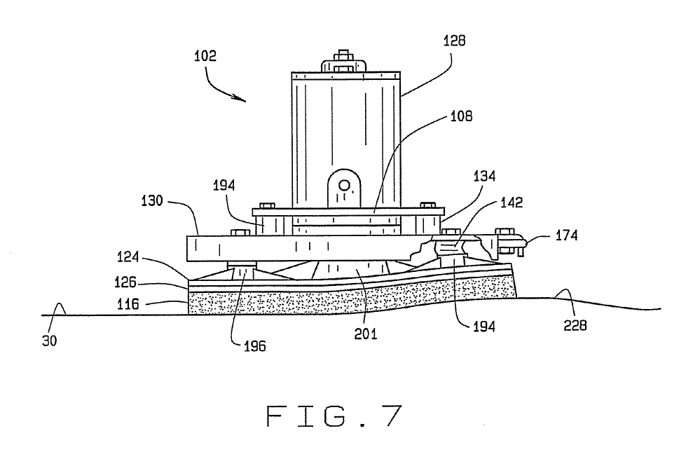

FIG. 7 is a side view of the cleaning head assembly 102 of FIG. 3 as it flexes to scrub another uneven floor surface 228. The left front lower vibration dampening element 142 is shown for illustrative purposes in an exaggerated deformed state. The cleaning element 116, the attaching means 126 and the pad driver 124 all flex to accommodate the uneven floor surface 228. Again the drawing is exaggerated for illustrative purposes. The motor mounting plate 130 may also tilt slightly to accommodate the uneven floor surface 228.

FIG. 8 is an exploded perspective view of the cleaning head assembly generally identified by the numeral 102 and the front of the orbital scrubber generally identified by the numeral 100. A support bracket 300 is mounted in the front of the orbital scrubber 100. The left flange 230 of the support bracket and the right flange 232 of the support bracket 300 are visible in this view. The proximal end 302 of the actuator 103 is pivotally mounted on a support element 304 extending from the support bracket 300.

An actuator pin 234 passes through a hole 236 in the left support arm 104, a hole 238 in the distal end of the actuator 103 and a hole 240 in the right support arm 106. Left pins 242 and right pins 244 pass respectively through holes 246 and 248 in the opposite ends of the actuator pin 234. A bolt 250 passes through a hole 252 in the proximal end of the left adjustment arm 104 and a hole 254 in the left flange 230. A nut 256 secures the threaded bolt 250. A bolt 258 passes through a hole 260 in the right adjustment arm 106. A nut 264 secures the threaded bolt 258. Thus the left adjustment arm 104 and the right adjustment arm 106 are pivotally mounted to the front end of the orbital scrubber 100 and their position is controlled by the actuator 103.

A bolt 266 passes through a hole 268 in the left yoke 112 and a hole 270 in the distal end of the left adjustment arm 104 and is secured by a nut 272. A bolt 274 passes through a hole 276 in the right yoke 114 and a hole 278 in the right adjustment arm 106 and is secured by a nut 280. In this fashion, the left adjustment arm 104 pivotally connects to the left mounting bracket 108 and the right adjustment arm 106 pivotally connects to the right mounting bracket 110 which allows the cleaning head assembly 102 to move from the upper non-scrubbing position of FIG. 2 to the lower scrubbing position of FIG. 3 when the actuator 103 is operated. As previously discussed, a control panel 16 is positioned at the rear of the machine, near the operator and a control mechanism regulates operation of the actuator 103. In addition to raising and lowering the cleaning head assembly 102, the actuator 103 applies downward load on the cleaning head assembly 102 while scrubbing. The amount of downward load can be adjusted by the control mechanism. Floor surfaces that are very dirty require more load on the cleaning head 102 for effective cleaning than floor surfaces that are lightly soiled. Skilled operators will adjust the load on the cleaning head 102 according to the level of dirt on the floor.

The actuator 103 is adjusted as follows by a control mechanism, not shown on the control panel 16, better seen in FIG. 1. The operation of the actuator 103 is well known to those skilled in the art; however, it is briefly explained herein for clarity. The control mechanism, not shown controls a reversible drive motor 306 operatively connected to a gear box 308. The gear box 308 connects to a threaded shaft, not shown in the actuator 103. When the motor 306 is operated in one direction it operates the gear box and the threaded shaft, not shown which lowers the cleaning element 116 of the cleaning head assembly 102 into contact with the floor as shown in FIG. 3. Further operation of the motor 306 places a downward load on the cleaning head assembly 102 and the cleaning element 116. When the motor 306 is operated in the opposite direction it operates the gear box 308 and the threaded shaft in the opposite direction, thus raising the cleaning head assembly 102 as shown in FIG. 2 so the cleaning element 116 can be replaced or the apparatus can be rolled about, for example to refill the solution tank.

As previously discussed, four upper vibration dampening elements, 134, 136, 138 and 140 are positioned between the motor mounting plate 130 and the mounting brackets, 108 and 110. Four lower vibration dampening elements, 142, 144, 146 and 148 are positioned between the motor mounting plate 130 and the pad driver 124. The eight vibration dampening elements a) help reduce vibration caused by the orbital movement of the pad driver 124 and cleaning element 116 and b) help the cleaning element adjust to uneven floor surfaces 126, 128 as illustrated in FIGS. 6 and 7.

One embodiment of the flexible pad driver 124 has four mounting pedestals 194, 196, 198 and 200 that connect to the four lower vibration dampening elements 142, 144, 146 and 148. A central mounting pedestal 201 is positioned in the center of the flexible pad driver 124. In one embodiment of the flexible pad driver 124, each of the mounting pedestals 194, 196, 198, 200 has a plurality of webs extending from the pedestal. For example, mounting pedestal 194 has a front web 282, a left web 284, a rear web, 286 and a right web 288. These webs provide structural support for the pedestal and help direct an even load on the cleaning element 116. The bumper wheels 174 and 176 have been eliminated from this figure to better depict other elements of the apparatus.

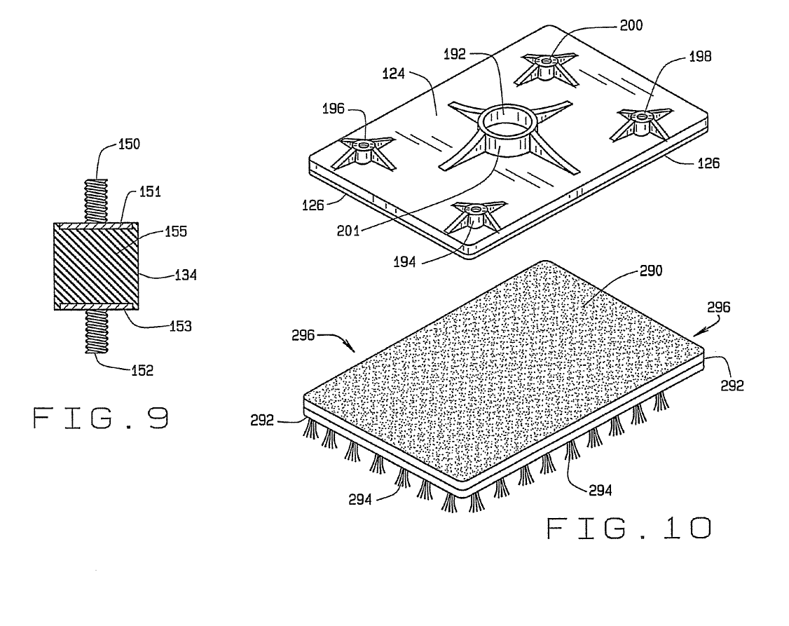

FIG. 9 is a cross-section of the vibration dampening element 134. The element 134 is the same as all the other vibration dampening elements, 136, 138, 140, 142, 144, 146, and 148 shown in the previous drawings. The vibration dampening element 134 has an upper threaded shaft 150 and a lower threaded shaft 152. The shaft 150 extends from a support plate 151 and the shaft 152 extends from a support plate 153. The body 155 of the vibration dampening element 134 is formed from natural rubber and has a durometer of 40, but other ratings may also be suitable. Applicant has determined that a rubber spring, model number 135-162 manufactured by Accurate Products, Inc. of Chicago, Ill. is suitable for this application. Man-made elastomers may also be suitable as well as other rubber springs from other manufacturers. In some applications, metal springs may also be suitable and are included in the definition of “vibration dampening element” as used in this application. Other types of vibration dampening elements may also be suitable as long as they have some degree of flexibility to allow the pad driver to adjust to uneven floor surfaces.

Table 1 below compares various features of the prior art BP-18 orbital scrubber with a 6″ 18″ cleaning element, the prior art Encore 17 rotary scrubber with a 17″ diameter rotary brush, the present invention having a 14″ 18″ cleaning element, the prior art Encore 2426 rotary scrubber with two 13″ diameter rotary brushes and the present invention having a 14″ 24″ cleaning element. The revolutions per spot are one way to gage the cleaning effectiveness of a machine. Table 1 makes it clear that the present invention has substantially more revolutions per spot than these prior art scrubbers.

TABLE 1

| | Pad | | | | | |
|---|---|---|---|---|---|---|
| | Size | Maximum | | | Forward | |
| | (sq | Pressure | | | Speed | Rev/ |
| | in) | (lb) | PSI | RPM | (ft/s) | spot |
| Orbital Scrubber | 252 | 90 | 0.4 | 2250 | 3 | 15 |
| 14″ × 18″ | | | | | | |
| Orbital Scrubber | 336 | 150 | 0.4 | 2250 | 4 | 10 |
| 14″ × 24″ | | | | | | |
| PRIOR ART | 108 | 45 | 0.4 | 1600 | 2 | 5 |
| BP-18 | | | | | | |
| Orbital 6″ × 18″ | | | | | | |
| PRIOR ART | 201 | 90 | 0.4 | 200 | 3 | 2 |
| Encore 17 | | | | | | |
| Rotary 17″ Diameter | | | | | | |
| PRIOR ART | 224 | 150 | 0.7 | 200 | 4 | 1 |
| Encore 2426 | | | | | | |
| Rotary 13″ Diameter | | | | | | |

Some of the data has been rounded up or down to simplify the presentation.

Table 2 below compares cleaning solution flow rates in various prior art scrubbers and the present invention. Solution flow rate will determine the solution run time of the scrubber. Table 2 demonstrates that the present invention with various sized cleaning elements has a lower flow rate and thus greater solution run time than these prior art scrubbers. Another bench mark of comparison is U.S. Pat. No. 6,585,827 assigned to Tennant Company. This patent states as follows: “One limitation of prior art scrubbers has been a relatively limited operational run time. For a typical scrubber with a 32 inch wide scrub swath and 30 gallon solution tank, the solution distribution rate varies between 0.5 GPM to 1.0 GPM. Run time based on solution capacity is between approximately 30-40 minutes.”

The solution flow rate of the present invention is between about 0.008 gal./in./min to about 0.017 gal./in./min. Since flow is measured in gallons/minutes it can vary depending on the size of the floor scrubber and width of the scrub head. Therefore, flow expressed in gallons/minute is not a good indication of the efficiency of a floor scrubber. Historically, very little attention has been given to the optimal amount of solution needed to clean a floor

Measuring the usage of solution in gallons/inch/minute gives a more accurate measure of solution use efficiency. The number of gallons of solution being used per each inch of scrub head width in one minute can be used as a measure of efficiency for any width of scrub head or any size scrubber.

It has been determined through testing that the optimum usage of solution for an orbital scrubber is about 0.008 to about 0.017 gallons per inch of head width in one minute. A heavily soiled floor may require up to about 0.017 gal/in/min and a lightly soiled floor may require only about 0.008 gal./in./min. Therefore, for any width of scrub head you will simply need to multiply this solution flow range times the scrub head width in inches to obtain the optimum amount of flow in gallons/min for any size scrubber. This technique eliminates any guess work as to how much solution should be used by any scrubber with any size width scrub head.

To calculate the maximum necessary solution flow rate for the present invention in the 18″ width, multiply the full flow setting of 0.017 gal/in/min times the brush head width of 18″ to get the flow rate of 0.31 Gal/min. To calculate the maximum necessary solution flow rate for the present invention in the 24″ width, multiply the full flow setting of 0.017 gal/in/min times the brush head width of 24″ to get the flow rate of 0.40 Gal/min. To calculate the maximum necessary solution flow rate for the present invention in the 28″ width, multiply the full flow setting of 0.017 gal/in/min times the brush head width of 28″ to get the flow rate of 0.48 Gal/min. To calculate the maximum necessary solution flow rate for the present invention in the 32″ width, multiply the full flow setting of 0.017 gal/in/min times the brush head width of 32″ to get the flow rate of 0.55 Gal/min. The following table compares the flow rates and usage rates for various theoretical embodiments of the present invention with various prior art devices.

TABLE 2

| | | | | | Solution | Total Area |
|---|---|---|---|---|---|---|
| | Cleaning Area | Usage Rate | Flow Rate | Tank | Run Time | Cleaned |
| | (sq/ft/min) | (Gal/in/min) | (Gal/min) | (gal) | (min) | (sq ft) |
| Orbital Scrubber | 259 | 0.017 | 0.31 | 11 | 77 | 19985 |
| 14″ × 18″ | | | | | | |
| Full flow setting | | | | | | |
| Orbital Scrubber | 515 | 0.017 | 0.40 | 20 | 50 | 25980 |
| 14″ × 24″ | | | | | | |
| Full flow setting | | | | | | |
| Orbital 14″ × 28″ | 601 | 0.017 | 0.48 | 20 | 42 | 25259 |
| Full flow setting | | | | | | |
| Orbital Scrubber | 726 | 0.017 | 0.55 | 30 | 57 | 41219 |
| 14″ × 32″ | | | | | | |
| Full flow setting | | | | | | |
| PRIOR ART | 216 | 0.059 | 1.1 | 5 | 4.7 | 1022 |
| BP-18 | | | | | | |
| Full flow setting | | | | | | |
| PRIOR ART | 245 | 0.010 | 0.18 | 11 | 61 | 14989 |
| Encore 17 | | | | | | |
| Rotary 17″ Diameter | | | | | | |
| Full flow setting | | | | | | |
| PRIOR ART | 558 | 0.028 | 0.74 | 20 | 27 | 15078 |
| Encore 2426 | | | | | | |
| Rotary 26″ Diameter | | | | | | |
| Full flow setting | | | | | | |

FIG. 10 is a perspective view of a flexible pad driver 124 and a removable cleaning brush generally identified by the numeral 296. The flexible pad driver 124 has a connecting means 126, which in this figure is a hook and loop device. The removable cleaning brush 296 includes a flexible plastic or nylon sheet 292 with bristles 294 extending from one side and a pad 290 located on the opposite side. The pad 290 removably engages the hook and loop device or other connecting elements 126 on the pad driver 124. The removable cleaning brush 296 and the removable cleaning pad 117 are both referred to as cleaning elements 116 in this application.

Those skilled in the art know that prior art rotary motion scrubbers use both brushes and pads as cleaning elements. To the best of applicant's knowledge, the pad drivers used in prior art rotary motion scrubbers, like the Encore series, are rigid for both brushes and cleaning pads. The present invention uses a flexible pad driver 124 for both removable cleaning pads 117 and removable cleaning brushes 296 of FIG. 10.

The present invention will give future designers of scrubbers for hard floor surfaces a number of design options, not previously available. With prior art rotary motion scrubbers, battery run time is not the primary limiting factor in scrubber design; instead, solution run time is the limiting factor. In other words, the operator must make several tank refills before the battery run time ends. In a perfect world, solution run time would equal battery run time, but no scrubber presently has achieved this lofty goal including the present invention. However, the present invention has reduced the number of tank refills to a lower level than any current rotary motion scrubber, including the Tennant Fast foam machine. This advantage has been achieved due to the low cleaning solution consumption rate of the present invention.

In addition, the present invention has reduced the consumption of electrical energy, which will also give future designers a number of options. For example, one brush motor will be all that is required on the present invention even in larger sizes. Some conventional rotary scrubbers use two brush motors on larger scrubbers. This reduces costs and may allow designers to reduce the battery size, if desired. Smaller batteries may also allow for enlarged solution and recovery tanks. The reduction in consumption of electrical energy has been achieved by the high speed orbital motion of the flexible pad driver along with other design features discussed herein.

The present invention can be designed with various features as discussed above. However, applicant has designed three theoretical embodiments described below that produce many of the advantages discussed herein.

TABLE 3
ORBITAL SCRUBBERS SPECIFICATIONS

| Cleaning | 18″ | | 24″ | | 32″ | |
|---|---|---|---|---|---|---|
| Width | | | | | | |
| Pad Size | 14″ × 18″ | | 14″ × 24″ | | 13″ × 32″ | |
| Pad Size in | 252 | | 336 | | 448 | |
| square inches | | | | | | |
| Maximum | 90 | lbs. | 150 | lbs. | 220 | lbs. |
| Load | | | | | | |
| PSI | 0.36 | | 0.45 | | 0.49 | |
| Brush Speed | 2250 | RPM | 2250 | | 2250 | |
| Forward Speed | 2.88 | Ft./Sec | 4.29 | | 4.3 | |
| Rev./Spot | 15 | | 10.2 | | 10.2 | |
| Orbit Diameter | ¼″ | | ¼″ | | ¼″ | |
| Power Supply | (2)12V130AH | | (2)12V130AH | | (2)12V330AH | |
| | WET | | WET | | WET | |
| | | | (2)12V330AH | | (2)12V370AH | |
| | | | WET | | WET | |
| Brush Motor | ¾ | HP | ¾ | HP | ¾ | HP |
| Traction Motor | ⅓ | HP | ½ | HP | ½ | HP |
| Vacuum Motor | ¾ | HP | ¾ | HP | ¾ | HP |
| Battery Run | 156 | min. | 396 | min. | 404 | min. |
| Time | | | | | | |
| Flow (full | 0.14 | gal/min | 0.40 | | 0.53 | |
| solution | | | | | | |
| setting) | | | | | | |
| Usage (full | .017 | (gal/in/min) | .0165 | | 0.017 | |
| solution | | | | | | |
| setting) | | | | | | |
| Tank Size | 11 | gal. | 20 | gal. | 30 | gal. |
| Solution Run | 77 | min. | 50 | min. | 57 | min. |
| Time | | | | | | |
| Total Area | 19,985 | sq. ft. | 25,980 | sq. ft. | 38,970 | sq. ft. |
| Cleaned | | | | | | |

| | | | |
|---|---|---|---|
| Weight w/ | 342 | 871 | 1038 |
| Batteries | | | |
| Weight w/ | 419 | 1011 | 1248 |
| Batteries | | | |
| and | | | |
| Solution | | | |

1. A method of cleaning a hard floor surface with a floor scrubber, the method comprising the steps of:
applying liquid cleaning solution to the hard floor surface in the proximity of a forward edge of a flexible cleaning element;
scrubbing the wet hard floor surface by movement of a flexible pad driver and a flexible cleaning element in an orbital path to loosen soil from the hard floor surface leaving behind a soiled solution;
applying an adjustable load on the flexible pad driver and flexible cleaning pad depending on how dirty the hard floor surface may be; and
removing at least a portion of the soiled solution from the hard floor surface through a fluid recovery device.

2. A method of cleaning a hard floor surface with a floor scrubber free of splash skirts, the method comprising the steps of:
placing a cleaning solution of water and concentrated floor soap in a solution tank of the floor scrubber;
contacting the hard floor surface with the cleaning solution;
scrubbing the wetted hard floor surface by movement of a flexible pad driver and the flexible cleaning element in an orbital path to loosen soil from the hard floor surface leaving behind a soiled solution;
placing an adjustable load on the flexible pad driver and the cleaning element to allow for accommodation of heavily soiled floor surfaces and those that are lightly soiled; and
removing at least a portion of the soiled solution from the hard floor surface through a vacuum squeegee.
